(19) United States
(12) Patent Application Publication
(10) Pub. No.: US 2024/0424870 A1
(43) Pub. Date: Dec. 26, 2024

(54) MOTOR VEHICLE

(71) Applicant: Dr. Ing. h.c. F. Porsche Aktiengesellschaft, Stuttgart (DE)

(72) Inventors: Rene Rohrberg, Eberdingen (DE); Bjoern Fischer, Stuttgart (DE); Timm Junge, Leonberg (DE)

(21) Appl. No.: 18/634,678

(22) Filed: Apr. 12, 2024

(30) Foreign Application Priority Data
Jun. 20, 2023 (DE) 10 2023 116 033.8

(51) Int. Cl. B60J 1/20; B62D 25/06

(52) U.S. Cl. CPC B60J 1/2075; B60J 1/2041; B60J 1/2052; B62D 25/06

(57) ABSTRACT

A motor vehicle (1) has an at least partially transparent roof (2) and a shading device (9) for darkening the at least partially transparent roof (2). The at least partially transparent roof (2) extends continuously with a curvature between a B-pillar (3) and a storage space (5) behind the B-pillar in the direction of travel (4). The shading device (9) has a shading part (12) that is guided laterally along a roof contour (10) in a rail system and is supported by transversely extending roof bows (11). A receiving box (13) is provided, in which the shading part (12) can be rolled up into a non-use position together with the roof bows (11).

### CROSS-REFERENCE TO RELATED APPLICATION

This application claims priority on German Patent Application No 10 2023 116 033.8 filed Jun. 20, 2023, the entire disclosure of which is incorporated herein by reference.

### BACKGROUND

### Field of the Invention

The invention relates to a motor vehicle that has an at least partially transparent roof.

Related Art DE 101 40 239 A1 discloses a motor vehicle with a sun blind device for placement under a transparent roof region of the motor vehicle. The sun blind device has a winding shaft that can be moved on lateral guides and displaced between a lowered rear-side storage position and at least one functional position spaced apart from the storage position under the transparent roof region.

DE 601 24 162 T2 discloses a device for covering at least one window pane and/or at least one opening of a motor vehicle. The covering device has a cover fabric web that can be moved between a folded and an unfolded position and at least one supporting and/or holding rod in a specified shape of the fabric web when it is unfolded. The rod or rods are separated from the fabric web at least when the fabric web is folded.

WO 2006/079 332 A1 discloses a darkening device for a light-impermeable window comprising a textile web that is mounted to be moved between a stored position and a deployed position. The darkening device also has a transverse reinforcement that is connected fixedly to the textile web and can slide between two guide rails disposed on either side of the darkened area.

DE 196 49 118 A1 discloses a cladding and insulation curtain for a cut-out opening in the body of a motor vehicle. The curtain is covered on the inside with a cladding, and has a panel mounted to slide with two lateral edges in two sliding guides that are associated with one another and connected to the body. This panel is made of slats, and, on an inner side opposite to the body, has a flexible coating layer that serves as cladding and insulation. The panel can be rolled up around an axis using a rolling device.

A sliding roof of a motor vehicle equipped with transverse slats is known from U.S. Pat. No. 4,923,244.

DE 102 30 444 A1 discloses a sliding sash for closing a body opening of a motor vehicle. Rods which are connected to a roller shutter with the interposition of seals and can be moved along parallel lateral guide rails and rolled up or unrolled from a drum by means of a motorized rotary drive to open and close the sliding sash.

The shading devices known from the prior art often are considered inadequate for darkening large glass surfaces.

The invention therefore focuses on the problem of providing a shading device that allows for comfortable, large-area shading and shielding of an interior of the motor vehicle from the surroundings.

### SUMMARY OF THE INVENTION

The invention relates to a shading device that can be used in a motor vehicle with a continuously curved and at least partially transparent roof between a B-pillar and a storage space behind the B-pillar in the direction of travel, for example a luggage compartment, so that the entire curved and transparent roof can be darkened to achieve the greatest possible darkening or shade effect. The shading device comprises a shading part and a receiving box. The shading part is guided laterally along a roof contour in a rail system and is supported by transversely extending roof bows. The shading part can be rolled up into a non-use position and can be received together with the roof bows in the receiving box. The shading device can darken the entire roof and prevents unwanted light from coming through the transparent roof. However, the shading part can be rolled up in the receiving box together with the roof bows and thus stored in a visually appealing and space-optimized manner if there is no need for shading. In its usage position, the shading part of the shading device can be extended to at least near the B-pillars and allows for large area darkening of the transparent roof that extends between the B-pillar and the luggage compartment behind the B-pillar in the direction of travel.

The shading part of some embodiments comprises a fabric or plastic web connected to the roof bows. Fabric webs and plastic webs can be used in nearly unlimited embodiments. The use of natural materials can provide a sustainable and environmentally-friendly touch. Plastic webs that are not or almost not transparent enable extremely effective shading or darkening.

In an alternate embodiment, the shading part comprises slats, and the roof bows are part of the slats or form the slats. This shading part thus is configured in the manner of a roller shutter and allows for particularly opaque darkening of the at least partially transparent roof across the entire area of the roof.

The roof bows of some embodiments are made of spring steel. Spring steel roof bows enable self-tensioning of the shading part, particularly if the shading part is connected to the roof bows in a tensioned manner. It is also possible to use struts or tension rods as alternatives to such roof bows. Angle profiles or hollow profiles are also conceivable and enable a particularly reliable stiffening of the shading part due to their higher bending torque.

The rail system may comprise two rails that curve along the roof contour. The individual roof bows are guided in these rails with their respective longitudinal ends guided in a noise-decoupled manner that enables a smooth quiet opening and closing of the shading device. The two rails of the rail system can be recessed on the side of the transparent roof along the roof contour in an inner lining of the headliner and/or a lateral rounding of the headliner and/or longitudinal roof frame.

The roof bows may be straight or curved. Straight roof bows advantageously can be rolled up extremely compactly. Curved roof bows can have the same curvature/shape as the curved and at least partially transparent roof and can be guided extremely close under the transparent roof or sunroof for increasing headroom and comfort. Roof bows that can be rolled up straight and can only be curved elastically under pretension (by pretensioning between the rails) can be used.

The motor vehicle can be an off-road coupe. Such off-road coupes can have a back seat under the transparent roof that is comfortable for passengers, and the shading device can provide direct sun protection for the passengers sitting in the rear seats.

The at least partially transparent roof expediently comprises a darkened area and also a clear view area behind it in the direction of travel, and the shading device can easily darken both the clear view area and the darkened area. The transparency of the darkened area can be reduced significantly or made non-transparent.

A side window and/or a triangular window in a side door can be darkened. The shading device and the darkened side windows or the darkened triangular windows can create protected privacy for individuals sitting on the back seat. Such a darkened side window also makes it impossible or difficult to see into the motor vehicle, which also makes it possible to transport objects on the rear seat bench out of sight.

The shading part may be configured as an acoustic decoupling element that reduces acoustic reflection on the at least partially transparent roof, thereby significantly improving the sound experience in the rear of the motor vehicle. This can be achieved by the use of relatively heavy knitted, woven or nonwoven fabrics with a high grammage.

Further features and advantages of the invention will emerge from the drawings and from the associated description of the figures.

It is understood that the aforementioned features and the features yet to be explained can be used in the respectively specified combination, in other combinations or on their own, without departing from the scope of the invention defined by the claims. The components mentioned above and the components yet to be mentioned below of a higher-level unit, such as a device, an apparatus or an arrangement, which are labeled separately, can constitute separate parts or components of this unit or can be integral regions or portions of this unit, even if shown otherwise in the drawing.

Preferred example embodiments of the invention are shown in the drawings and are explained in further detail in the following description, wherein identical reference signs refer to identical, similar, or functionally identical components.

### BRIEF DESCRIPTION OF THE DRAWINGS

FIG. 1 is an interior view of a motor vehicle according to the invention in the region of the back seats.

FIG. 2 is a sectional view through the motor vehicle.

### DETAILED DESCRIPTION

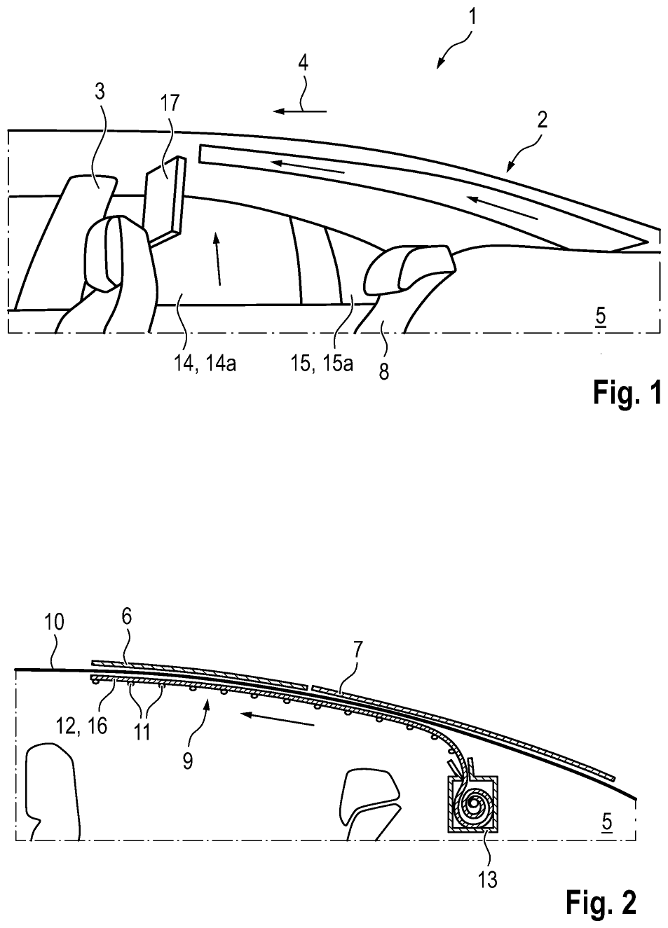

A motor vehicle according to an embodiment of the invention is identified by the numeral 1 in FIGS. 1 and 2 and in this example is as an off-road coupe. The motor vehicle 1 comprises a continuously curved and at least partially transparent roof 2 between a B-pillar 3 and a storage space 5 behind the B-pillar in the direction of travel 4. A large area of the roof 2 can be made of glass and comprises a darkened area 6 and a clear view area 7 (see also FIG. 2). The roof 2 is curved in the region of the darkened area 6 and the clear view area 7, for example as a so-called heli-window. The darkened area 6 and the clear view area 7 can be configured in one piece or as one part, but also in multiple parts. The darkened area 6 can be darkened using tinted glass or a film.

A shading device 9 is provided for darkening the at least partially transparent roof 2 to give individuals sitting on a back seat 8 a commensurate feeling of freedom and also a so-called cocoon effect. The shading device 9 has a shading part 12 that is guided laterally along a roof contour 10 in a rail system and is supported by transversely extending roof bows 11. This shading part 12 can be stowed together with the roof bows 11 in a space-saving manner in a non-use state or a non-use position in a receiving box 13 (see FIG. 2). The receiving box 13 is behind the back seat 8 in the direction of travel 4.

The shading device 9 is configured to shade or darken both the clear view area 7 and, if desired, the darkened area 6 of the transparent roof 2, thus protecting a person sitting on the back seat 8 from direct sunlight. The shading part 12 can be extended to the B-pillar 3 or at least near the B-pillar 3 when it is extended. Thus, opening the shading device 9 can create the feeling of a convertible even though the roof 2 is closed. Extending the shading element 12 enables a protected and cocoon-like seating position on the back seat 8. To further support such a cocoon effect, a side window 14 and/or a triangular window 15 can be darkened too. This can be achieved with appropriately tinted side windows 14a or tinted triangular windows 15a and/or with films.

The shading part 12 can comprise a fabric or plastic web 16 that is connected to the roof bows 11 and is extremely flexible and thus easy to roll up. Alternatively, the shading part 12 can comprises slats, and the roof bows 11 can be part of the slats or form the slats. This makes it possible to create a roller shutter effect.

The roof bows 11 can also be made of spring steel or alternatively configured as tension rods that enable the shading part 12 to open automatically. As can be seen in particular in FIG. 2, the shading device 9 or its shading part 12 has a longitudinal curvature in the in-use state. However, a transverse curvature of the shading part 12 can be achieved with curved roof bows 9. A curved shape of the roof bows 11 allows the shading element 12 to be guided directly along the roof 2, i.e. at a distance of a few millimeters from the at least partially transparent roof 2, as a result of which the headroom of individuals sitting on the back seat 8 is not or only insignificantly restricted. The roof bows 11 alternatively can be straight, which enables a particularly compact arrangement in the receiving box 13.

The motor vehicle 1 of this embodiment is configured as an off-road coupe and provides space for four people, i.e. at least two people on the back seat 8, which can be configured as a rear seat bench. Curved roof bows 11 are an ideal option to increase headroom for this body shape, namely a coupe in which the roof line slopes down toward the rear. The shading device 9 makes it possible to prevent light inadvertently coming through the transparent roof 2, in particular the clear view area 7, so that even individuals sitting on the back seat 8 do not have problems viewing a vehicle display 17 or a laptop on the individual's lap.

The at least partially transparent roof 2 makes it possible to achieve an open-to-the-sky driving experience with the motor vehicle 1 according to the invention when the shading device 9 is open, whereas closing the shading device 9 makes it possible enable glare-free work on a back seat 8 and absolute privacy.

1. A motor vehicle (1) comprising:
an at least partially transparent roof (2) extending continuously with a curvature between a B-pillar (3) and a storage space (5) behind the B-pillar in a direction of travel (4);
a shading device (9) for darkening the at least partially transparent roof (2), the shading device (9) comprises a shading part (12) that is guided laterally along a roof contour (10) in a rail system and is supported by transversely extending roof bows (11); and
a receiving box (13) in which the shading part (12) can be rolled up into a non-use position together with the roof bows (11).

2. The motor vehicle (1) of claim 1, wherein the shading part (12) comprises a fabric or plastic web (16) connected to the roof bows (11).

3. The motor vehicle (1) of claim 1, wherein the shading part (12) comprises slats, and the roof bows (11) are part of the slats or form the slats.

4. The motor vehicle (1) of claim 1, wherein the rail system comprises two rails that curve along the roof contour (10).

5. The motor vehicle (1) of claim 1, wherein the roof bows (11) are straight.

6. The motor vehicle (1) of claim 1, wherein the roof bows (11) are curved.

7. The motor vehicle (1) of claim 1, wherein the roof bows (11) are made of spring steel.

8. The motor vehicle (1) of claim 1, wherein the motor vehicle (1) is configured as an off-road coupe.

9. The motor vehicle (1) of claim 1, wherein the at least partially transparent roof (2) comprises a darkened area (6) and a clear view area (7) behind the darkened area (6) in the direction of travel (4).

10. The motor vehicle (1) of claim 1, further comprising at least one side window (14) and/or at least one triangular window (15) that is darkened.

11. The motor vehicle (1) of claim 1, wherein the shading part (12) is configured as an acoustic decoupling element.
